(19) United States
(12) Patent Application Publication
(10) Pub. No.: US 2012/0173436 A1
(43) Pub. Date: Jul. 5, 2012

(54) Method and system for authorizing, authenticating, implementing, brokering data transfers, and collecting fees for data transfers among distributed electronic devices and servers

(76) Inventor: Stanley Benjamin Smith, Fort Mill, SC (US)

(21) Appl. No.: 13/134,596

(22) Filed: Jun. 11, 2011

Related U.S. Application Data
(63) Continuation-in-part of application No. 12/930,280, filed on Jan. 3, 2011.

(51) Int. Cl. G06Q 20/00

(52) U.S. Cl. 705/77

(57) ABSTRACT

The invention provides a method and system to register, initiate, authenticate, authorize, draw from a price or fee schedule, and enable electronic devices, including “cloud” appliances capable of running computer readable code to perform data transfers and collect transaction fees for data forwarded or relayed to other electronic devices. The method includes generating and sending read-write pairs of activation keys across electronic devices authorizing data transfers from or between the devices, enabling data transfers from or between the devices, most often authorizing payment to at least one of the users associated with the devices for transferred data or for transaction fees associated with the data or both. In this manner, any electronic device capable of processing computer readable code can be used to facilitate data transfer and payment authorizations between a device functioning as a host or brokering server and one or a plurality of other electronic devices that generate, create, host, transmit or accept data.

### BACKGROUND OF THE INVENTION

1. Field of the Invention

This invention relates to methods and systems for exchanging and processing payment for data generated by or housed within electronic devices using activation keys or other methods for verifying the identity of users and devices contributing data to a data supply chain.

2. Description of the Related Art

Many electronic devices automatically create and log or store data as they perform functions intrinsic to their use and design, such as storing GPS location information or reading and storing scans of UPC bar codes. Many of these devices run computer readable code to automatically generate, store, calculate, and otherwise process data and information; or enable users to input, store, calculate, and otherwise process data or information. Some of these devices implement instructions or computer readable code for producing and storing data hard wired into the processor of the device. Data collected through these electronic devices may have value to a data federator, a data aggregator, or a researcher. Owners and users of these electronic devices, however, have rights to the data generated on or by their devices, and have a right to sell or transfer ownership of that data. Social network vendors or other data federators or participants in a data supply chain may be required to obtain permission or pay for data before they download or upload it for use, repurposing, or redistribution.

The invention relates generally to the field of fees, prices, schedules, and processes for data transfer, and in particular to the transfer of data between two entities or users of electronic devices where data may be manually entered by the user or generated through embedded software or through hardware housed on or within an electronic device as part of the systems or processes enabled by or through the device. Logs of activities of purchases made from retail outlets or restaurants, caches of history of websites visited, stored search term histories, details of email addresses and subject lines for sent or received emails or SMS messages, and purchases of tickets for entertainment or sports events are just a few examples of data that may not be of much interest to the user of an electronic device that is storing the data, but may have significant value for a data federator who could make use of the data for marketing analysis or logistical analysis or other purposes.

The invention enables owners of data generated by or stored within electronic devices to sell or voluntarily transfer that data to another entity. Some of these entities are data federators. Data federators will typically federate or aggregate the data on their servers and then sell or distribute portions or subsets of the federated data to other users for purposes such as market research or trend analysis. This invention additionally enables the distribution of data to multiple potential users directly, as a gateway or conduit, without requiring the data to be federated or folded into the database of a data federator. When the invention is used in this manner, the device serving as the host computer functions as a data distributor or broker wherein the seller of the data and the buyer of the data are able to achieve the exchange. In cases where the invention is used for brokering of data, one or both or all of the participants in the brokerage relationship may be required to pay a transaction fee for services, processes, methods, and systems that enable the data exchange. This is similar to how stock brokerage firm will charge a transaction fee for enabling clients of the firm to purchase or sell shares in publicly traded companies.

Current data transfer authorization procedures typically involve a series of email or other exchanges between the data federator and the data generator and often include sharing personal information, such as names and addresses of the sender of data and recipient of the data, and banking information. Once an authorization to transfer data has been collected and confirmed from the sender, the recipient or host may collect additional information from the sender regarding a method for paying the agreed amount into an account at a financial institution or other type of payment exchange entity. The recipient may also be required to provide a data transfer payment authorization number and/or proof of identification prior to the data exchange. Typically, this procedure is followed for each data transfer, even when the sender and recipient are the same persons for multiple instances of data exchange and the devices sending or receiving the data are the same devices. As a result, frequent or routine data transfers require repetitive data transfer payment authorizations of much the same information. Both creators and generators of data as well as federators of data can benefit from a more efficient method for executing data exchanges and for payment for these data exchanges.

Prior art is quite broad in the arena of activation keys and validation routines associated with these keys. Since 1910 banks have used ABA routing numbers or routing transit numbers as keys to enable transfers of funds. Collection of routing numbers for both the banks and numbers for individual accounts involved in these transfer have been a common business method. Other forms of electronic transfer such as EFTS are also common. In these cases, a debtor or buyer gives a bank account number and routing information to a creditor or vendor and that party transfers the money from the account. This is also the system often used as part of a bank's online bill payment service. EFTS transfers differ from wire transfers in that an EFTS payment is essentially an electronic personal check, whereas a wire transfer is more like an electronic cashier's check. EFTS transfers are sometimes called “ACH transfers,” because they take place through an entity called the Automated Clearing House. One advantage to an EFTS transfer over a wire transfer is that the recipient of the funds can initiate the transfer. The method f this invention is aimed at enabling both and sellers of data to initiate transfers and collect or exchange payment.

Prior art also exists for many variations for generation and configuration of activation keys. Some call the keys “validation” keys. Others call them “registration keys,” “installation keys,” “license keys. “product keys,” “encryption keys,” or “unlock keys.” In most cases, these keys are not paired as they are in this invention, but in some cases these keys are paired together with one key sometimes labeled an “activation key” and the key paired with it being labeled an “installation key.” It is a common expectation when transferring funds for both parties to the transfer to exchange one or both keys of a pair of keys. This invention lays no claim to methods or systems for generating keys to be used for validation, authentication, or activation; rather, it introduces new art that extends the use of these keys beyond the single function or purpose of activation or registration or authentication or financial transfer between two parties to a method that links these keys with persons who create or input data, with electronic devices that create or generate data, with payment processing organizations such as financial institutions, and with federators or aggregators or researchers who purchase and interpret and use the data. In short, the method of the invention facilitates the repurposing of data and the business processes required to achieve the repurposing.

It will be apparent to those skilled in the art that the use of a pair of activation keys is an effective shortcut to facilitate the process of data exchange. The method of this invention leverages the electronic generation and exchange of activation keys, but it is not dependent upon them for effective embodiments. Reciprocal codes generated through an independent electronic device or through manually entered sets of information readable by an electronic device of any type in any format can be effective in achieving the objectives of the method for enabling data exchange described herein.

Current art teaches that data sources may be linked and fees or prices may be charged for enabling these linkages of data sources across servers. [Smith (U.S. Pat. No. 7,860,760)]. Current art further teaches that data exchange itself can trigger further actions including concatenating data exchange among many data sources on many devices or servers. However, a method to build keys, exchange these keys, and use these keys to facilitate payment of fees for data is not included in the scope of the prior art. The method and systems of this invention when integrated with prior art [Smith (U.S. Pat. No. 7,860,760)] will further enable a data economy, where data is a commodity traded easily and effectively in a free and open market.

Additional prior art also teaches a system and method for implementing a pricing agreement between data owners contributing data to a data supply chain or federated data source [Smith (Ser. No. 12/930,280)]. This patent is a Continuation in Part of Ser. No. 12/930,280 and expands the method wherein a host server may link data fields and data sources and charge fees for the fields or data sources folded into a data supply chain. Additional prior art, also a Continuation in Part of Ser. No. 12/930,280, teaches that fees and prices may be charged for use of a GUI to process transfers of ownership of data. Additional prior art, also associated with Ser. No. 12/930,280 teaches that fees for data sources or individual data fields may be adjusted according to the weight or reputation of the source of the data, the popularity of the data field or dataset, the recency or creation data of the posting of the field, and so forth.

There is no prior art teaching a method to use activation keys to facilitate a brokerage relationship wherein data sources and data fields are linked or uploaded or exchanged and payment for facilitating or brokering the exchange and payment for the data itself is implemented.

### SUMMARY OF THE INVENTION

The invention relates generally to authorization, pricing, payment, transferal, and recording of data transfers between two or more electronic devices or entities or users. The invention provides systems and methods to initiate, facilitate, process and/or perform data transfer authorizations and collect fees for data included in the transfer as well as transaction fees for facilitating the transfer. In one such embodiment, a method for processing data transfer includes receiving a request for a read-write pair of activation keys to ensure correct data transfers between a synchronous and an asynchronous subsystem or between two asynchronous subsystems from a server or electronic device, and verifying that the read-write pair of activation keys are associated with valid read-write activation key records. The method includes sending the read-write pair of activation keys to ensure correct data transfers between a synchronous and an asynchronous subsystem or between two asynchronous subsystems to the server or electronic device linked to the server; sending or receiving a data transfer payment authorization request associated with the pair of activation keys from the server or electronic device; authorizing a data transfer payment to at least one of a first and second or a plurality of users associated with the read-write pair of activation keys; and initiating the transfer of the data itself and the exchange of payments through a third party or vendor of financial transaction services such as Paypal or a bank. In this manner, a server or electronic device can be used to authorize a data transfer, implement the data transfer, collect payment for the data transferred and/or collect a fee for facilitating the data transfer between two or more users who have an established read-write record of information or configuration file associated with a pair of activation keys.

One option in an embodiment of the invention includes establishing a record of the read-write pair of activation keys associated with the first user and the second or a plurality of users. The record of the read-write pair of activation keys may be established, for example, by verifying the identity of at least one of the first and second users, receiving first and second user information, creating a database record, and providing a read-write pair of activation keys to at least one of the first and second users. The read-write pair of activation keys also may embed a data transfer payment authorization and instructions, such as scheduling data transfers and payments and recipient addresses and designations into the character strings that comprise the read-write pair of activation keys.

Another option in an embodiment of the invention is the sending of a fee request to the server or electronic device along with the read-write pair of activation keys. The fee request may be a data transfer authorization fee to be charged to the user initiating the data transfer. The fee may be fixed or variable. Note that this fee is not for the data itself, but for the authorization obtained through the exchange of the read-write pair of activation keys. However, the fee request itself, once verification is accomplished, may trigger transfer of data as instructed in the read-write record that includes the activation key.

Another option in an embodiment of the invention is the creation and inclusion of a record for a payment schedule to be associated with the server or electronic device or with a data source on the device. The payment schedule may indicate the amount to be transferred and the schedule for the transfer. In some instances the payment amount would be fixed and the amount embedded or stored within the record of the read-write pair of activation keys themselves. This capability will be useful for users who want to transport data each week, or each month, or as a number of data points reaches a pre-set volume threshold.

In some embodiments a data transfer authorization associated with a data transfer request may be associated with either the first or second or a plurality of users. In this case, one of the users sends a read-write pair of activation keys prior to being assigned the data transfer authorization. In this manner, the intended recipient or plurality of recipients exchange or offer their read-write pair of activation keys, and possibly other proof of identity, prior to receiving an authorization to transfer the data.

Embodiments of the invention can provide alternative methods to authorize and facilitate data transfer. One embodiment includes receiving a data transfer request and a read-write pair of activation keys from a first user. The pair of read-write keys is then forwarded to a host computer for verification. If the verification is not achieved the data transfer request is denied and no data will be transferred. Another alternative is to process the data transfer request and generate an authorization after user information is collected. This alternative enables a payment requested by the first user to be transferred to a second or a plurality of users associated with the read-write pair of activation keys, and sending a record of the data transfer and the concomitant instructions for payment to the host computer enabling payment to a second or a plurality of users. In some cases, a receipt is provided to the first user. In other cases a portion of the transfer occurs through another electronic device or server in a series or a relay system. Some cases may enable some or all of the transaction to occur using a website interface or a voice recognition device, or even a human service representative. Provided verification is achieved, these transactions may move forward between already registered entities and users or a combination of already registered entities and those using the method of read-write pair of activation keys, thus limiting repetitive or unnecessary collection of information or data for each transaction.

Embodiments of the invention are particularly useful for authorizing data transfer in real time, such as while one or a plurality of users authorized for data transfer with valid keys respond to an event invitation or notice sent to participants in a social network. In one case, the method includes receiving a purchase request for a data field from the first user. The payment may be divided into portions associated with the data field, the data distribution process or targets, the authorization itself, the recipient, or other consideration relating to the value of the data as well as the process for distributing the data or even the devices or gateways used for distribution. This enables more efficient electronic devices or users to include a premium for their efficiency. The use of a read-write pair of activation keys previously established by the first and/or second user will reduce or eliminate the amount of personal information collected in order to authorize the data transfer. In some embodiments, the initiating user need only provide the read-write pair of activation keys and post data to be transferred into an electronic clipboard or other cached memory on an electronic device and computer readable code reads and writes from the activation keys to trigger the data transfer.

Embodiments of the invention can be flexibly applied to hard wired electronic devices to initiate, perform, process and facilitate data transfer authorizations. One such embodiment includes the host computer's processor being connected or linked to a data source and running computer readable code to verify a read-write pair of activation keys from another electronic device. The host computer may also execute computer readable code to receive requests for data transfer associated with the read-write pair of activation keys from an electronic device, and then execute computer readable code to authorize a data transfers and authorize payment to at least one of a first user and a second user associated with the read-write pair of activation keys. In this manner, the data transfer and payment authorization may be initiated from a third electronic device. In some embodiments, the electronic devices themselves may be loaded with a device driver or a series of drivers that activate automatically when the device is turned on to automate some or all of the verification and connection process with minimal or no input from a user or owner of the device other than the act of owning or purchasing or registering the device itself.

In one embodiment, a kiosk housing a device with a connection to a host server may be placed in an area, such as a retail mall, and a user or owner of an electronic device may connect the device through a port or cradle for their device within the kiosk to implement the transactions described in the claims for this invention. In this embodiment, laptop datasets or mobile phone logs or other data sources on portable electronic devices can be uploaded to a federator if the user/owner/seller of the data has established a record of information that includes linking instructions to data federator, payment transfer instructions to a fund exchanging entity, acceptance of a schedule of fees, and a valid pair of activation keys.

In some aspects, the system additionally includes computer readable code for converting the information input into a record of information to configure and generate a record of the read-write pair of activation keys associated with the first user and the second or a plurality of users as well as to generate the keys themselves. The read-write pair of activation keys is then provided to at least one of the first or a plurality of users along with the record of information.

Other objects, features and advantages of the invention will become more fully apparent from the following detailed description, the appended claims, and the accompanying drawings.

### BRIEF DESCRIPTION OF THE DRAWINGS

FIG. 1 is an example of processes driven by an electronic device implementing the invention.

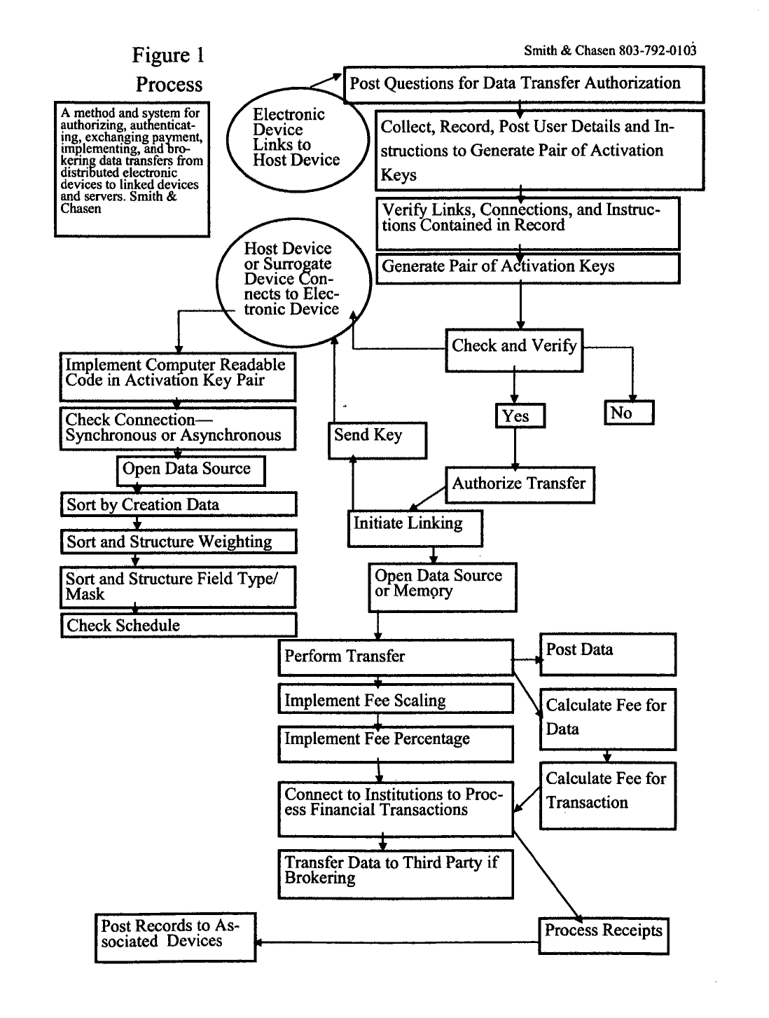

FIG. 2 is a diagram of instruction options for activation keys, records of activation, and associating data transfer records with activation keys.

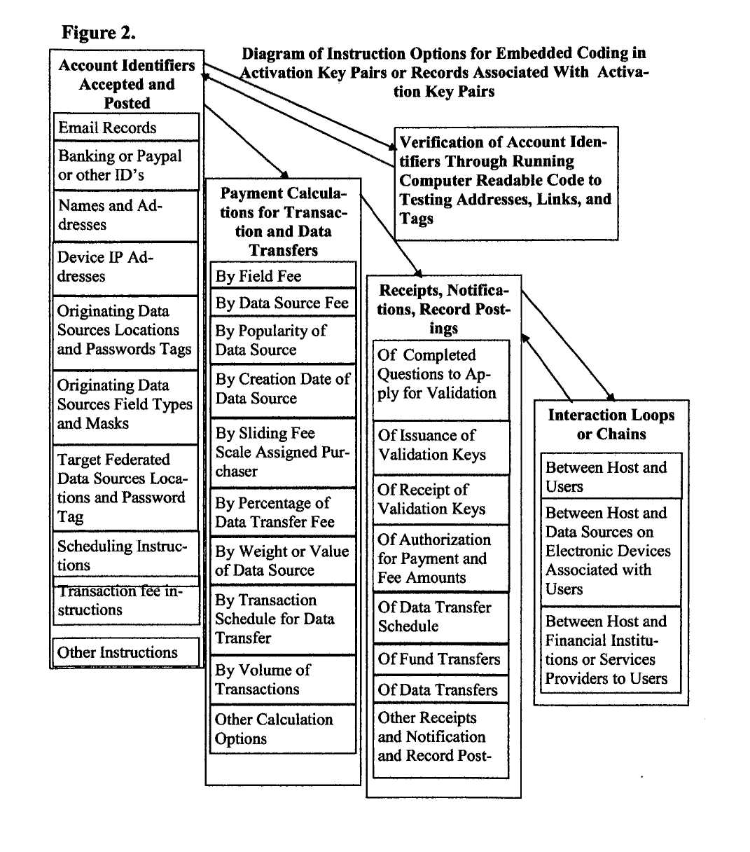

FIG. 3 is a diagram of event sequences.

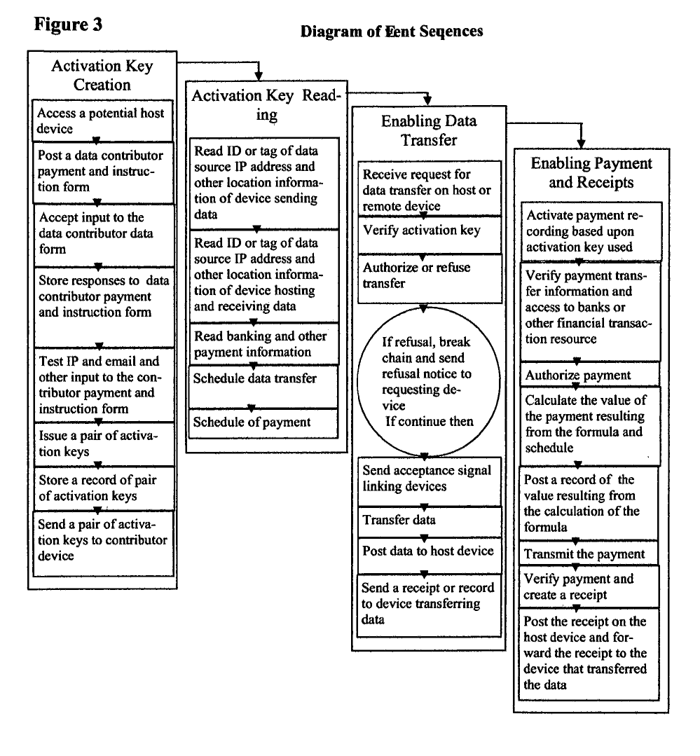

FIG. 4 is a diagram of relationships between users and device.

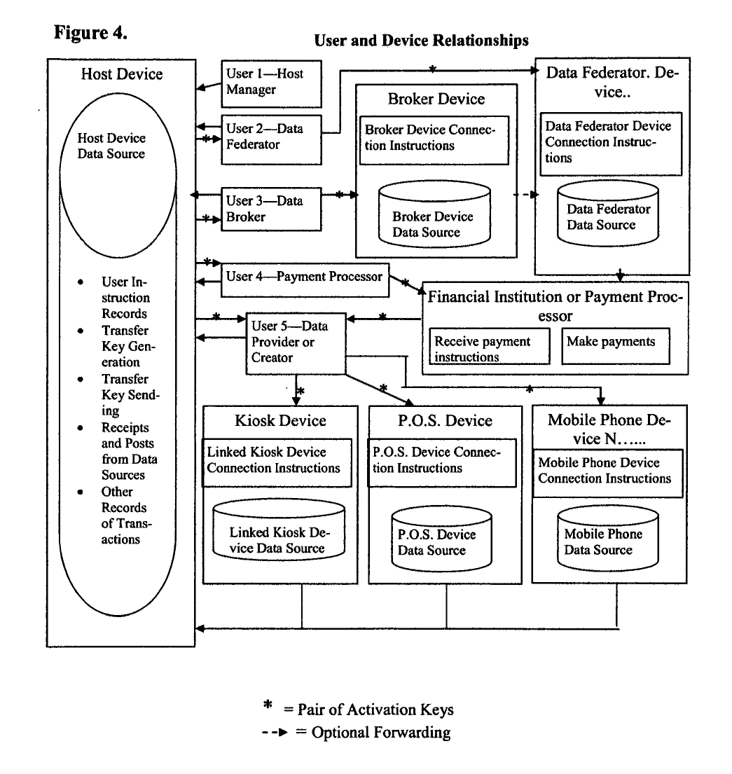

FIG. 5 is a diagram of relationships between activation keys, users and devices.

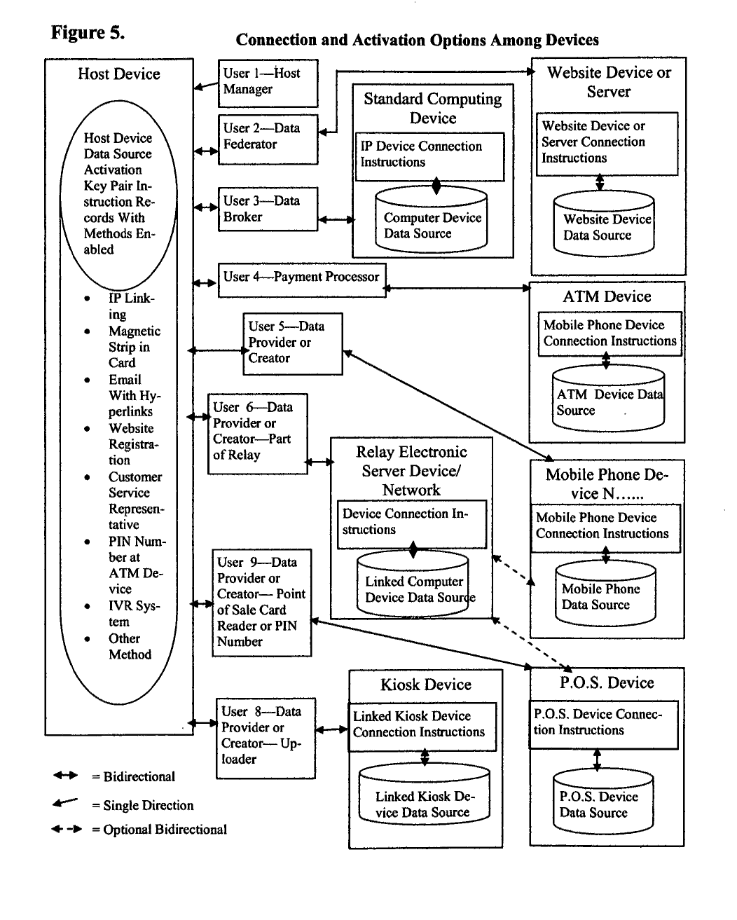

FIG. 6 is a diagram of the relationship between the record of information and creation of data transfer tools such as activation keys or device drivers.

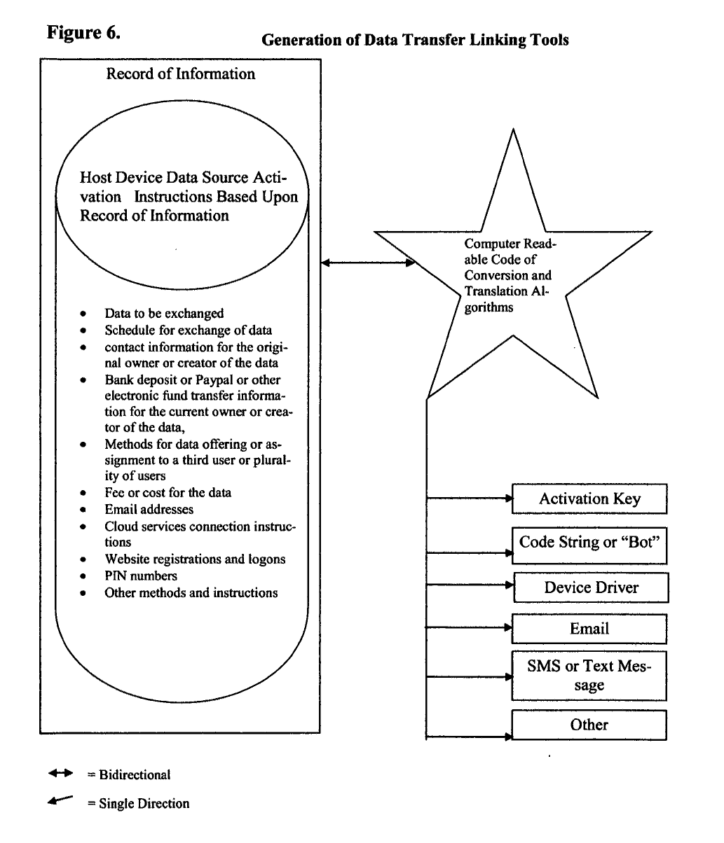

FIG. 7 is a diagram of interactions between users, servers or devices, and payment processors.

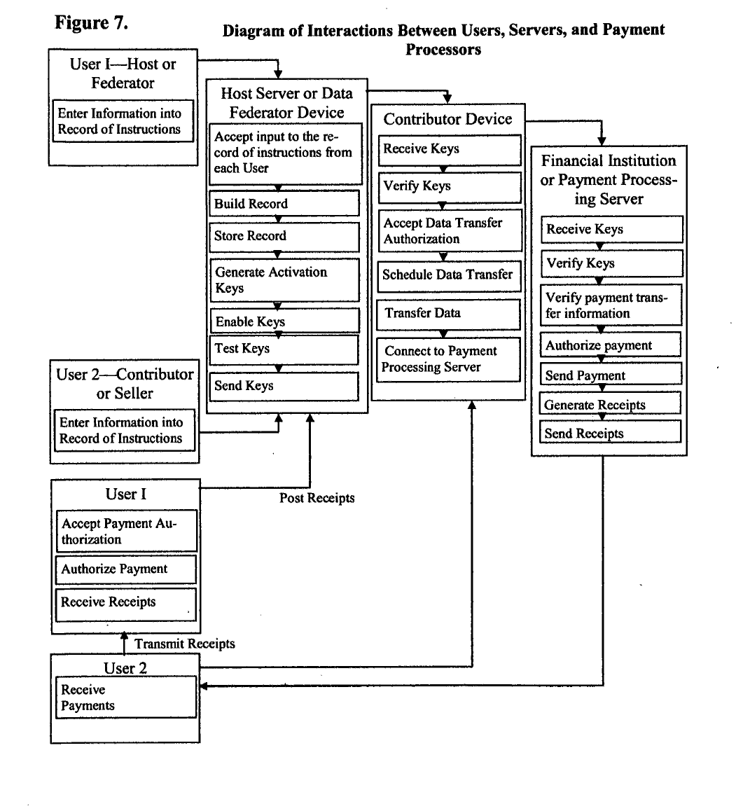

FIG. 8 is an additional diagram using icons to illustrate interactions between users, data stores, servers or devices, and payment processors in a typical embodiment.

### DETAILED DESCRIPTION OF THE INVENTION

The invention includes systems and methods that initiate, facilitate, process and/or perform data transfers and authorize calculate collect or otherwise process payment for performing data transfers. These transfers may occur in a series or sequence between two devices, servers, entities, or users. The embodiments of the invention will be particularly useful for users who send data on a regular basis to the same person or server or a few persons or servers and who need to manage the authorization of the data transfers and collect fees for data they send, including enabling the collection of transaction processing fees. These data transfers and authorizations may occur at regular intervals and may correspond to instances when data is created in the course of the operation of an electronic device or posted into an electronic device through software or linking protocols such as OLAP or ODBC. Some embodiments of the invention will be particularly useful to reduce the amount of information users must provide each time they authorize the sending of data and collect payment for the data and/or collect a transaction fee for processing the exchange of the data. Additionally, many more options for generating data transfer, authorizing data transfer, paying for the data, and paying for processing or brokering of the data exchange will be available through use of the system and method of the invention.

When a pair of activation keys is created for a pair of users, one or both users is required to provide information for the record associated with the activation keys. This information in the record and its verification is the heart of the method enabling the transaction. Verbal or visual or other verifications of identification could just as easily replace or displace the use of a pair of activation keys. As technology changes and thumbprints or retinal scans and other verification methods to confirm identity become widespread, the need for confirmation of identity enabled through activation keys will decrease, but the devices involved and the data to be exchanged and the transaction fees and transfer of funds among accounts will remain a benefit resulting from the method of this invention. This information typically includes IP addresses of the devices, locations addresses or tags for the data sources on the devices, and banking or financial information. Either party to the transaction may create the record of information to associate with the data transfer. There are expected to be many variations in the number and types of data fields to be used or collected to build a complete record of information for data transfers, especially if multiple electronic devices are linked into the data transfer process. Records of information are, in effect, a container of both configuration instructions and identifying information for parties engaged in data transfer and payment for data transfers.

When a host server is also a data federator, the need for reciprocal banking or financial information may be excluded and payment can be made directly to the contributor of the data from an account associated with the data federator. If a host server will broker or relay a transactions between two or a plurality of users, financial information may be required for both users. Information associated with the pair of activation keys may include many additional details, such as telephone numbers, cell phone numbers, email addresses, social security numbers, dates of birth, driver license numbers, employee identification numbers, passwords, credit card information, bank account information, information on other payment mechanisms, or similar information. In some embodiments, the amount or type of personal or payment or device information for a first and a second or a plurality of user may differ. For example, if the second user is always going to be the data recipient, the amount and type of information may be more or less than the information collected for a first user.

Recording information associated with a pair of activation keys can be performed in a various ways depending on the particular embodiment of the invention. A user may, for example enter data transfer addresses for multiple electronic devices or servers and provide the information needed for data transferal on each of the electronic devices or servers. The information may be offered to a representative of the entity owning the host server through a phone call or in an email form or through series of chat screen entries using an instant messaging system, or through postings into forms on a website. This may occur, for example, when a first user is the only party transferring data to a second user. The information associated with a pair of activation keys will commonly be collected and entered into a computer-based system using computer readable code that can create and store a record of the information. Mobile or wireless devices may also be used to collect the required information for a pair of activation keys and then port the information up to a server or enable the mobile or wireless device itself to operate as a server.

In a preferred embodiment, the creation of the record of information associated with a pair of activation keys produces one or more embedded instructions in the pair of activation keys to connect to devices of the first user and second or a plurality of users associated with the record of information linked to a pair of activation keys. The record of information associated with the pair of activation keys is collected from one or both users and may in turn be provided to one or both users or a plurality of users. A record of information associated with a pair of activation keys can be utilized in a variety of ways in various embodiments of the invention. For example, embedded instructions may be placed into the pair of activation keys to enable the keys to initiate computer readable code to implement instructions to initiate or trigger an executable computer readable program file on a device.

In another embodiment, the pair of activation keys can be used by one or both users the same way a personal identification number or “pin” number is used with an automated teller machine. The pair of activation keys may in yet another embodiment be hyperlinked through an email message similarly to the way some software registrations and activations are achieved. In some embodiments, the activation keys may be printed into the magnetic strip on a credit card so it will be readable by a credit card reader. Users can insert the card into a card reader to confirm that a data transfer and payment authorization has been processed by querying the server that receives the data and then initiate authorized financial transactions. There are many possible variations of these methods and systems in the scope of this invention beyond the examples offered above.

Once a record of information associated with a pair of activation keys has been created and stored, the configuration instructions for creating the activation keys can shape how the pair of activation keys can be used to initiate data transfer and authorizations for payment and other processing from variety of locations and in a variety of ways. In some embodiments, a user initiates the data transfer and payment authorizations by logging onto a website. The embedded instructions in the pair of activation keys can be copied and pasted into a website field so data transfer and payment authorization associated with the activation keys and their users can be processed. The website may prompt the user to provide additional information such as Captcha technology or a password, to verify that the individual interfacing with the website is indeed one of the first or second users. The initiation of data transfer and authorization for payment using embedded instructions in the pair of activation keys can also occur through an IVR system through phone systems. Additionally, the first user may call a customer service representative associated with the host device or a user designated through the host device to provide activation keys, payment methods, and/or transfer schedules. In some embodiments, the payment method may be limited to methods already identified in the record of associated with a pair of activation keys, such as a credit card account, or a Paypal or other account. In some embodiments, receipts for portions or all of the transaction can be processed through email or a voice message, or even a paper receipt sent to a user's physical address, and so forth. A common embodiment of the invention includes the implementation of embedded computer readable code contained within the sets of computer readable characters within the pair activation keys if these keys are stored on an electronic device and the electronic device is used for a function enabled on or within or through the device, such as the use of a supermarket identity card in a retail purchase transaction.

A typical embodiment of the invention includes a host computer system connected to a data source. In one embodiment, the host system is a server capable of creating and maintaining records associated with data transfer. The host computer system may be operated by a third party. The data source will house and maintain records of data transfers, data fee charges, data transfer transaction charges, data transfer schedules, authorizations for data transfer, authorizations for payment for data transfers, the data transferred, records and receipts for payments and data transfers, records of activation codes and keys, and records of users of the method of the invention. In one embodiment a data source contains some or all records associated with a pair of activation keys. The host server may provide user interfaces for customer service representatives or interactive voice systems to accept data to use to create a record associated with a pair of activation keys.

In one embodiment, the record of information associated with a pair of activation keys would be created for a first user and a second user where the second user is to be the recipient of a data transfer payment authorization initiated by the first user. In order to receive the data transfer authorizations the second user would interact with a remote terminal or system. In alternative embodiments, the data transfer authorizations are directly linked to an account for the second user at a financial institution.

Yet another embodiment enables a remote system comprising a computer system, linked or associated data sources, and other electronic devices to run computer readable code to coordinate the data transfer authorizations, data transfers, payment of fees for data, and payment for transaction processing through remote devices or servers. Combining remote electronic devices with host servers may be direct or through wireless or hard wired networks, or through the Internet or through telephone lines or through satellite signals or through what is lately called the “Cloud.”

Devices used to transmit and process authorizations and other activities related to data transfer may also be coupled to networks for credit cards or Automated Teller Machines, or they may linked to other computer systems. While a host server may be a single machine, it may also have multiple components and be linked together in a series of systems or devices that perform other or additional functions not directly related to this invention. Some processes associated with the invention may be maintained on one server, while records of information associated with activation keys are maintained on another server or device. Many data sources may be used to store and retrieve records of transactions. In some embodiments, an electronic device linked to the system may be located at a petroleum station or distribution warehouse or be hard wired into or connected to a component of a point of sale device. A services or product vendor may link to a host server to implement the method of the invention whenever there is a perceived benefit in exchanging or selling data. Some users may choose to associate or link data fields from other data sources on their electronic devices or servers such as the names of employees or the job titles of employees performing some of the transactions or services involving data source transfer authorizations and the data itself for drilling down into relationships by business intelligence software or other analytic tools.

Whenever the host server confirms that the pair of activation keys corresponds to a valid record of information associated with the keys, a data transfer authorization can be processed along with initiation of methods for transferring data and collecting fees. There is an embodiment of the invention that may enable credit and debit accounts for users with valid activation keys. This can be especially useful for reciprocal data sharing or trading, such as a furniture vendor, an appliance manufacturer, and a home builder where the size of the house informs the furniture vendor of the scale for furniture construction and the price per unit of furniture sold informs the appliance manufacturer of the likely market for different appliances or models of appliances.

Many alternatives transactional and configurational possibilities are available within embodiments of the invention. One example is dividing data transfer payment authorization fees and fees for data transfers into percentages paid to the owner of a host server and the owner of a remote device. Another is communicating via a network to the host device in order to facilitate data transfers and payment authorizations. Yet another is to automatically initiate computer readable code housed on the host device to open a data source on the host device to initiate a data transfer and payment authorization process. Yet another is for a data federator to set up a host device to operate as a clearing house where data is vetted and processed or evaluated in some fashion prior to authorizing a permanent transfer and associated fees and payments.

A data transfer may be initiated by any user receiving a pair of activation keys along with a data transfer payment authorization. The activation keys will contain a minimum of one embedded instruction for processing data transfer transactions based upon information entered into the configuration instructions for activation keys entered into the record of information created when one of the users opted to register to authorize data transfers. These instructions entered into the record of information may direct or further configure processes in many ways other than direct transmission or data transfer and payment authorizations. An example is the initiation of an authorization and data transfer cycle, including payment for the data through the very act of an electronic device reading a UPC code or reading the activation keys on a magnetic stripe on a credit card, or through reading of activation keys by a point-of-sale device.

At any point a request for verification of the keys is initiated, the method of the invention may begin to be implemented. If any device does not receive a verification, the data transfer authorization process is discontinued. If the keys are valid and a verification is transmitted, data transfer may continue and payment may be by any of the means identified in the record of information associated with the activation keys. In some embodiments, a data transfer payment fee is deducted from the data transfer payment authorization amount requested. Procedures following receipt of payments may take multiple forms and consist of multiple sub-processes, including posting or sending of records or notifications that the data transfer has been successfully performed and that the data transfer fee has been collected.

If the pair of activation keys is not verified, a denial notification is sent to the electronic device of the user requesting a data transfer authorization. The denial notification may also be transmitted from that device to all electronic devices connected to the device originating the request. A denial may occur for a variety of reasons, including incorrect embedded instructions in the pair of activation keys, an incomplete record of information associated with a pair of activation keys, a message or notice placed in record of information associated with a pair of activation keys indicating additional data transfer authorizations should be denied, and so forth.

The records of information may generate keys that contain or enable additional options for either party to a data transfer including additional or alternative options for payments for data transfers. Examples are variable payment or no payment at all. For example, instructions entered into the record of information may, in some embodiments, allow only temporary time window for transfer of data, while in another the instructions would structure continual exchanges of data in real time—a permanent link across devices. Further examples are cases where a record of information instructs keys to be built that enable one or all devices to create or store a record of all transactions and all users associated with the pair of activation keys. Keys may be built that authorize data transfers payments of a designated amount (fixed or variable) and may indicate how data transfer fees or payments can be dispensed to a second or third or a plurality of users upon proof of identity. In some embodiments, a data transfer payment authorization is available to a second user only after a period of time has passed since a prior payment. In this manner, payments made for a data transfer can be approved or further evaluated or confirmed before assigning further funds.

The advantages of the invention are numerous. The user of any electronic device will have multiple methods and means and locations from which they can initiate data transfers and receive payment for them. Additionally, the user need not repeatedly provide all of the information needed for data transfers or payment as most or all of the information is maintained in the record of information associated with the pair of activation keys. Benefits to the data federator or data broker are also numerous. For example, the federator will be assured that information contained in the record of information associated with the keys allows for proper authorization, verification, validation, allocation, assignment, management, payment, and correct processing of the data along with accumulation and posting transactional records into a data source. The data federator or broker also benefits by not being required to enter a complete record for a data source owner each time the data source owner or the federator wants to transfer data. It will be appreciated by those skilled in the art that additional benefits to each of the parties of the methods of the invention, arising from one or more of the methods or processes or components of the systems of the invention may be realized within the scope of the invention.

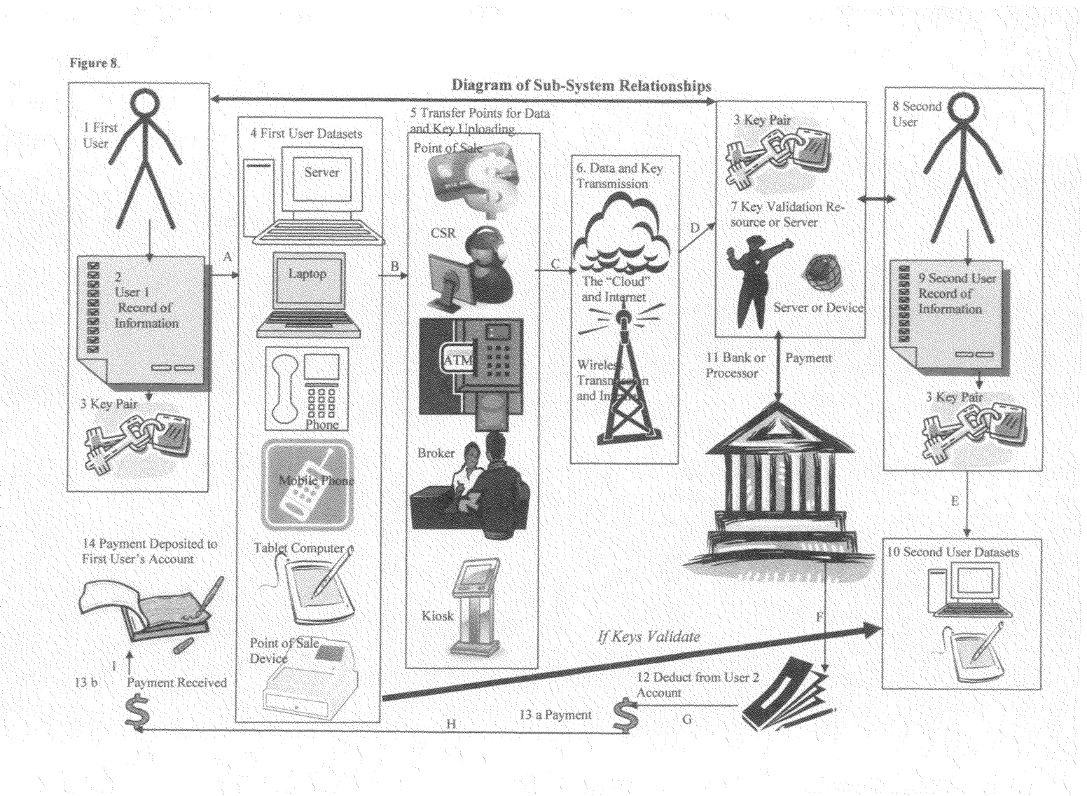

FIG. 8 in the set of drawings illustrates the relationships among sub-systems for the methods of the invention. The First User (1) sets up the record of information (2) that informs and instructs the construction of the pair of keys (3). The second user (8) also sets up a record of information (9) that is also used to construct the pair of keys (3). The bold line from the First User to the key validation resource or server (7) and the bold line from the Second User (8) to the key validation resource or server enables a transfer with concomitant transfers of funds from a payment processor (11), also connected through a bold arrow. The un-bolded arrows (A through I) illustrate a typical sequence of events where the First User builds the Record of Information and opens a dataset (4) to transfer at a Transfer Point (5), such as a kiosk dock or from a point of sale device. When the data and the associated keys are transmitted (6) they are processed by a Key Validation Resource or Server (7) that tests the keys to determine whether the financial and the data transaction may proceed. If the keys check, the transaction proceeds and the Second User (8) and the Bank or Payment Processor (11) are notified and the data is posted to the Second User's Datasets (10). Monies are deducted from the account (12) of the Second User (8) and a payment (13) is sent to the bank account (4) of the First User (1).

The invention may be implemented in ways other than those discussed and many changes and modifications are within the scope of the appended claims. Accordingly, embodiments of this invention are not limited to the specific examples offered above, but may be achieved through the range of options and choices implied and outlined in the following claims.

What is claimed is:

1. A method and system enabling electronic devices to utilize records of information of at least a first and second or a plurality of users to authorize transfers of data, transfer data, collect fees for the data transferred, and collect fees for processing data transfers, the method and system comprising:
receiving by a first electronic device capable of running computer readable code, a request for a read-write pair of activation keys to ensure correct data transfers between a synchronous and an asynchronous executing subsystem or between two asynchronous executing subsystems from a second or a plurality of electronic devices;
posting into a screen on the first or host device one or a plurality of questions to be completed by the user of a second or a plurality of electronic devices regarding one or a plurality of identification and processing instructions, such as the type of data to be exchanged, locations or tags for data to be exchanged, formats or structure of the data to be exchanged, the schedule for exchange of data, contact information for the original owner or creator of the data, bank deposit or Paypal or other electronic fund transfer information for the current owner or creator of the data, how or whether data may be offered for resale or assigned to a third user or plurality of users, the fee or cost for the data, an indication of acceptance of the fee or cost for transferring the data to the second or a plurality of electronic devices or users, and other questions that may be pertinent to enable and facilitate data transfers and implement secure financial transactions;
accepting by the first electronic device from the user of the second or a plurality of electronic devices the responses to the series of questions;
implementing computer readable code by the first electronic device to test the validity of responses to the questions, such as tests of email addresses offered by user of the second or a plurality of electronic devices, the IP connection of the second or a plurality of electronic devices, the validity of financial account information, the locations and tags of the data sources on the second or a plurality of electronic devices, the structure and format of the data on the second or a plurality of electronic devices, and run other tests to confirm the validity or accuracy of the responses to the series of questions;
generating through computer readable code or drawing from a set housed in a data source on the host device, a read-write pair of activation keys of computer readable characters for at least one of the users;
sending by the host device or first user, the read-write pair of activation keys to a second device or plurality of devices or a second user or plurality of users;
enabling verification by all included devices that the read-write pair of activation keys of computer readable characters are associated with a valid pair of activation key records stored in memory or a data source on at least one or more of the electronic devices;
verifying by all included devices that the read-write pair of activation keys of computer readable characters are associated with a valid pair of activation key records stored in memory or a data source on at least one or more of the electronic devices;
sending by the device of the second user or plurality of users a confirmation of receipt of the read-write pair of activation keys and authorization to implement data transfers wherein the data transfer authorization may include payment amounts or fees for the data transferred;
sending by the device of the second user or plurality of users a confirmation of receipt of the read-write pair of activation keys and authorization to implement data transfers wherein the data transfer authorization may authorize a payment amount or fee for a data transfer transaction;
receiving by the device designated as a host device a data transfer receipt associated with the a read-write pair of activation keys from the second or a plurality of electronic devices, wherein the data transfer authorization may include a payment amount or fee for the data transferred;
receiving by the device designated as a host device a data transfer receipt associated with the a read-write pair of activation keys from the second or a plurality of electronic devices, wherein the data transfer authorization may include a payment amount or fee for the transaction enabling a data transfer;
authorizing by the device serving as a host or first user a data transfer payment amount or fee to a second or a plurality of electronic devices associated with the pair of activation keys;
sending by the host device a data transfer payment authorization amount to be paid to the second user or a plurality of users, wherein the data transfer payment authorization fee may be drawn from a data transfer fee schedule;
authorizing by the host device a data transfer payment authorization fee comprising a fee authorized by the electronic device functioning as a host server to the second user or a plurality of users upon acceptance of the fee;
establishing a data transfer fee record associated with the host user and the second or a plurality of electronic devices;
verifying the identity of at least one of the first and second users;
receiving first and second or a′plurality of user information from a record of information and creating and posting a database record thereof;
sending by the host device or first user a data source identification code or schedule or label or tag, wherein the data source identification specifies one or a plurality of data sources housed on the second or a plurality of electronic devices;
sending by the host device or first user computer readable code to search for or discover a data source or label or tag, wherein the data source identification specifies one or a plurality of data source housed on the second or a plurality of electronic devices;
sending by the host device or first user computer readable code to enable pushing or pulling data from one or a plurality of data sources housed on the second or a plurality of electronic devices;
initiating computer readable code on the second or a plurality of devices to enable one or a plurality of data sources on a device to establish a link or connection to the device serving as a host or first user to enable the host to pull data from the second or a plurality of electronic devices;
initiating computer readable code on the second or a plurality of devices to push data to the host server from the second or a plurality of electronic devices;
initiating computer readable code on the host device to pull data to the host server from the second or a plurality of electronic devices;
initiating computer readable code on the host device to post a data source that will accept postings from the second or a plurality of electronic devices;
initiating computer readable code on the host device to access, open, transfer and post data to data sources on one or a plurality of accessed electronic devices;
establishing a data transfer record associated with the host device and the second or a plurality of electronic devices;
posting and storing the data transfer record into a data source on the host device:
posting and storing the data transfer record into a data source on the second or a plurality of electronic devices;
and initiating computer readable code on the host device to transfer funds to or accept payment from the second or a plurality of accounts associated with users of the associated electronic devices according to the record of instructions for financial transactions on the host server.

2. The method as in claim 1 wherein the read-write pair of activation keys is associated with one or a plurality of users and comprises a designator for the recipient of the data to ensure correct payment for data transfers between a synchronous and an asynchronous executing subsystem or between two synchronous executing subsystems and additionally comprises sending a fee request to the server or electronic device;
receiving the read-write pair of activation keys associated with the first or second or a plurality of users prior to the assigning of one or a plurality of data transfer payment authorizations;
collecting fees from the accounts authorized by one or a plurality of users associated with the read-write pair of activation keys associated with the first or second or a plurality of users;
transferring fees to the accounts authorized by the one or a plurality of users associated with the read-write pair of activation keys associated with the first or second or a plurality of users;
posting payment receipts and records of the financial transactions to the records of one or a plurality of users associated with the read-write pair of activation keys associated with the first or second or a plurality of users;
sending payment receipts and records of the financial transactions to one or a plurality of users associated with the read-write pair of activation keys associated with the first or second or a plurality of users;
and receiving payment receipts or records of the financial transactions corresponding to the data transfer payments authorized or requested from the host server.

3. The method as in claim 2 wherein the read-write pair of activation keys is associated with one or a plurality of users and comprises a payment authorization for data based upon a single or a plurality of attributes of the data being authorized for transfer including;
accepting a data transfer payment authorization fee amount based on a sliding scale of the data transfer payment authorization amount;
accepting a data transfer payment authorization fee amount based on a percentage of the data transfer payment authorization amount;
accepting a data transfer payment authorization fee amount based on the creation date of the data being transferred;
accepting a data transfer payment authorization fee amount based on a weight or value assigned by the host server or first user to the data being transferred;
accepting a data transfer payment authorization fee amount based on a mask or format or field type of the data being transferred;
accepting a data transfer payment authorization fee amount based on a specific data field or plurality of fields of the data being transferred;
accepting a data transfer payment authorization fee amount based on the type of device housing or originating the data being transferred;
or accepting a data transfer payment authorization fee amount based on a popularity rating value assigned by the host server or drawn from a third party ranking source acceptable to the first user and the second user or a plurality of users for the data being transferred.

4. The method as in claim 3 wherein the read-write pair of activation keys is associated with one or a plurality of users and comprises an authorization for payment based upon a single or a plurality of attributes of the data being authorized for transfer and assigning the data transfer authorization associated with the data transfer payment authorization request to the first or second or a plurality of users and the data transfer payment authorization amount associated with the read-write pair of activation keys.

5. The method as in claim 1 for processing data transfer authorizations, comprising the host computer sending computer readable code of a set of instructions which cause the processor on an electronic device to initiate;
providing a read-write pair of activation keys to at least one of the first user and a second or a plurality of users;
establishing a record of the read-write pair of activation keys associated with the first user and second or a plurality of users;
receiving user information from a first or a second or plurality of users and creating data source record to include a read-write pair of activation keys;
receiving a request to verify a read-write pair of activation keys from another electronic device or server;
verifying that the read-write pair of activation keys are associated with a valid record of a read-write pair of activation keys record;
sending a read-write pair of activation keys to ensure correct data transfers between a synchronous and an asynchronous executing subsystem or between two asynchronous executing subsystems to the included or listed electronic devices;
receiving a data transfer authorization associated with the read-write pair of activation keys from the included or listed electronic device, wherein the data transfer authorization includes a data transfer payment amount;
authorizing a data transfer to at least one of a first user and a second user or plurality of users associated with the read-write pair of activation keys;
and sending a data transfer payment fee amount to the receiving server or electronic device, wherein the data transfer payment fee amount is determined according to a fee schedule;

6. The method as in claim 1 of processing data transfers, the method comprising:
receiving, by a host computer system, from a second user or a plurality of users, a request for a read-write pair of activation keys to ensure correct data transfers between a synchronous and an asynchronous executing subsystem or between two asynchronous executing subsystems, wherein the request includes a request to enable scheduled or routine data transfers and payments associated with the read-write pair of activation keys;
verifying, by the host computer system, the read-write pair of activation keys are associated with a valid record of read-write pair of activation keys;
establishing, by the host computer system, a schedule for data transfer for the read-write pair of activation keys based on the schedule;
sending, by the host computer system, the read-write pair of activation keys to ensure correct data transfers between a synchronous and an asynchronous executing subsystem or between two asynchronous executing subsystems to the server or electronic device;
and authorizing, by the host computer system, data transfer to a recipient associated with the read-write pair of activation keys pair based on the schedule.

7. The method as in claim 4, wherein the initiation of the data transfer and payment or collection may be upon changes within a data source housed on the second or a plurality of contributing devices, an hourly transfer schedule, a daily transfer schedule, a weekly transfer schedule, a monthly transfer schedule, a bi-monthly transfer schedule, a quarterly transfer schedule, a bi-annual transfer schedule, an annual transfer schedule, or a schedule set by any of one or a plurality of the of the users associated with an activation key;

8. The method as in claim 4, wherein the initiation of payment or collection may be based upon cumulative amounts or ranges or upon initiation of data transfers in real time or upon a schedule correlated with the transfer of the data or upon an independently established schedule.

9. The method as in claim 6, comprising verifying the identify of at least one of the senders and one of the recipients.

10. The method as in claim 6, comprising in response to verifying the read-write pair of activation keys, sending the host device and the second or a plurality of devices a notification indicating that the read-write pair of activation keys has been verified.

11. The method as in claim 6, comprising in response to authorizing at least one of the data transfers, confirming by the host device permission from the second user or the plurality of users who have responded to the questions posed in claim 1, to transmit the data to a plurality of other users or devices.

12. The method as in claim 4, comprising in response to authorizing at least one of the payments for data transfers, and sending the recipient a notification indicating that the data transfer payment has been authorized according to the agreed schedule.

13. The method as in claim 4, comprising in response to authorizing at least one of the payments for data transfers, sending the recipient a notification indicating that the data transfer payment has been paid according to the agreed schedule.

14. The method as in claim 4, comprising in response to authorizing at least one of the payments for data transfers, sending the recipient a notification indicating that the data transfer payment has occurred.

15. The method as in claim 1, comprising posting into a screen on the first or host device a series of questions to be completed by the user of a second or a plurality of electronic devices regarding the type of data to be exchanged, locations or tags for data to be exchanged, formats or structure of the data to be exchanged, the schedule for exchange of data, contact information for the original owner or creator of the data, bank deposit or Paypal or other electronic fund transfer information for the current owner or creator of the data, how data may be offered for resale or assigned to a third user or plurality of users, the fee or cost for the data, an indication of acceptance of the fee or cost for transferring the data to the second or a plurality of electronic devices or users, and other questions that may be pertinent to enable and facilitate data transfers and implement secure financial transactions:
storing the record of information in a database on one or a plurality of electronic devices associated with the user who created the record for posting onto websites or cloud computing services presentation screens associated with the user;
implementing a conversion or translation of one or a plurality of the data fields in the database record into instructions readable by an electronic device to be posted into an activation key;
implementing a conversion or translation of one or a plurality of the data fields in the database record into a distributable computer readable program or “bot;”
implementing a conversion or translation of one or more of the data fields in the database record into a device driver that can be hardwired or installed into an electronic device;
and implementing a conversion or translation of one or a plurality of the data fields in the database record into one or a plurality of emails or SMS text messages that can be forwarded to one or a plurality of users by the user who created the record of information or by his designated and authorized and verified representative.
